(19) United States
(12) Patent Application Publication
(10) Pub. No.: US 2007/0127496 A1
(43) Pub. Date: Jun. 7, 2007

(54) Method, system and apparatus for creating a reverse tunnel

(76) Inventor: Paula Tjandra, Hoffman Estates, IL (US)

Correspondence Address: MOTOROLA, INC., 1303 EAST ALGONQUIN ROAD, IL01/3RD, SCHAUMBURG, IL, 60196, US

(21) Appl. No.: 11/293,894

(22) Filed: Dec. 5, 2005

(51) Int. Cl. H04L 12/56

(52) U.S. Cl. 370/395.52

(57) ABSTRACT

A method, system, and apparatus for creating an Internet Protocol (IP) based reverse tunnel is described. The method includes receiving at an external agent (112) a registration request message from a mobile station (106). The method further includes sending from the external agent, an extension with the registration request message indicating support for creation of the reverse tunnel. Further, the method includes sending an extension together with registration reply from the local agent (110) to the external agent allowing the creation of the reverse tunnel if the extension from the external agent indicates that the reverse tunnel is supported by the external agent.

### FIELD OF THE INVENTION

The present invention relates generally to mobile communication, and more specifically, to the creation of reverse tunnels in a communication system.

### BACKGROUND OF THE INVENTION

The Internet is interconnections of mobile stations that enable its users to access information and communicate with other mobile stations. All mobile stations are identified by a globally routable address. Internet Protocol (IP) addressing is used to allocate globally routable address to a mobile station. A globally routable address is generated based on the mobile station's point of attachment. Further, each mobile station is a computational device that can be stationary (for example, a desktop computer) or mobile (for example, a laptop computer or a mobile phone).

A mobile station can be a migratory node that moves from one fixed network to another but utilizes the Internet only when physically connected to any network. A mobile station can also be a roaming node that can maintain a connection to the Internet, even while it is moving from one fixed communication network to another. The mobile station may or may not be present in different communication networks. For example, a laptop is connected through a Wireless Fidelity (WiFi) network to the Internet and then the laptop switches to another WiFi network. Another example may be a mobile station, such as a cell phone, that moves from one communication network of General Packet Radio Service (GPRS) connectivity to another communication network.

Communication between mobile stations is not addressed by the conventional IP addressing scheme. A separate scheme, known as Mobile IP, allows a mobile station to be identified by a single address, or home address, regardless of its current physical point of attachment. The usage of the home address makes mobility transparent to applications and makes it appear that the mobile station is continuously able to receive data on its home network. To enable this, the networked environment is divided into distinct networks, foreign (or external) network and home (or local) network. The foreign network is defined as the network where the mobile station is currently located. The home network is defined as the network which assigns the mobile station's home address. A foreign network could have one or more foreign agents (or external agents). The foreign agent monitors the mobile stations visiting that foreign network. Further, each home network has a home agent (or a local agent) that monitors the mobile stations that are associated with the home network, and are currently visiting other (foreign) networks.

When a mobile station is not attached to its home network, the home agent is responsible for delivering all traffic destined for the mobile station to the mobile station's current point of attachment. Another address, or Care-of Address (COA), is used to identify the mobile station's current point of attachment with respect to the network topology. Whenever the mobile station changes its point of attachment, it registers its new Care-of Address with its home agent. There are two different types of Care-of Address: Foreign Agent Care-of address and co-located Care-of Address. Foreign Agent Care-of Address is an address of a foreign agent with which the mobile station is registered attached to. Co-located care-of address is an address assigned solely to the mobile station from the foreign network. In other words, the co-located care-of address is an externally obtained local address which the mobile station has attached with one of its own network interface.

Mobile IP assumes that all nodes in the Internet have addresses that are within the same globally routable address space. However, with the number of mobile stations exceeding the number of addresses available, service providers assign a private or disparate IP address to the mobile stations. The mobile station with a private IP address or disparate IP address may visit a communication network where its address is not routable, since a private address is not routable in a public domain but is routable only in the private domain. Consequently, data packets addressed to the mobile station would not reach it. The concept of private IP address allocation is defined in RFC 1918 (Rekhter, et al., “Address Allocation for Private Internets”). A private IP address is not routable in the public network but permits full network layer connectivity among all devices inside an enterprise. The advantage of using private address space is to conserve the globally unique address space by not using it where global uniqueness is not required. The concept of a disparate IP address is often used in corporations which have several properly allocated address ranges. They advertise reach-ability to only a subset of those ranges, leaving the others for use exclusively with the corporate network. Since these ranges are not routable in the general Internet, their use leads to the same problems encountered with the private IP addresses, even though they are not taken from the ranges specified in RFC 1918.

To solve this problem, a tunnel is created from the local agent to the care-of-address of the mobile station. Another problem arises when the mobile station tries to communicate with another mobile station (with a private or disparate address) in the mobile station's home network. However, the current protocol for reverse tunneling solution implicitly assumes that all mobile stations are capable of obtaining reverse tunnel through Mobile IP registration request message. Further, many legacy mobile stations do not support this feature and would need to be upgraded or replaced.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of an abstract model of a communication system supporting communication of mobile station across different networks, in accordance with one embodiment of the invention.

FIG. 2 is an example of an external agent in accordance with one embodiment of the invention.

FIG. 3 is an example of a local agent in accordance with one embodiment of the invention.

FIGS. 4 and 5 represent an exemplary process flow diagram illustrating a method for communicating between mobile stations in accordance with one embodiment of the invention.

FIG. 6 represents a block diagram of an apparatus for creating a reverse tunnel in a communication network, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE EMBODIMENTS

Before describing in detail embodiments that are in accordance with the present invention, it should be observed that the embodiments reside primarily in combinations of method steps and apparatus components related to communication between mobile stations. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

A “set”, as used in this document, means a non-empty set (i.e., comprising at least one member). The term “another”, as used herein, is defined as at least a second or more. The terms “including” and/or “having”, as used herein, are defined as comprising. The term “coupled”, as used herein with reference to electro-optical technology, is defined as connected, although not necessarily directly, and not necessarily mechanically. The term “program”, as used herein, is defined as a sequence of instructions designed for execution on a computer system. A “program”, or “computer program”, may include a subroutine, a function, a procedure, an object method, an object implementation, an executable application, an applet, a servlet, a source code, an object code, a shared library/dynamic load library and/or other sequence of instructions designed for execution on a computer system.

A method and system for creating a reverse tunnel in a communication network is disclosed. The communication network includes at least one mobile station and a plurality networks. The reverse tunnel is created from an external agent to a local agent. The external agent receives a registration request message from the mobile station. The external agent sends an extension with the registration request message to advertise support for creation of the reverse tunnel. The local agent sends a reply to the external agent allowing the creation of the reverse tunnel based on the extension.

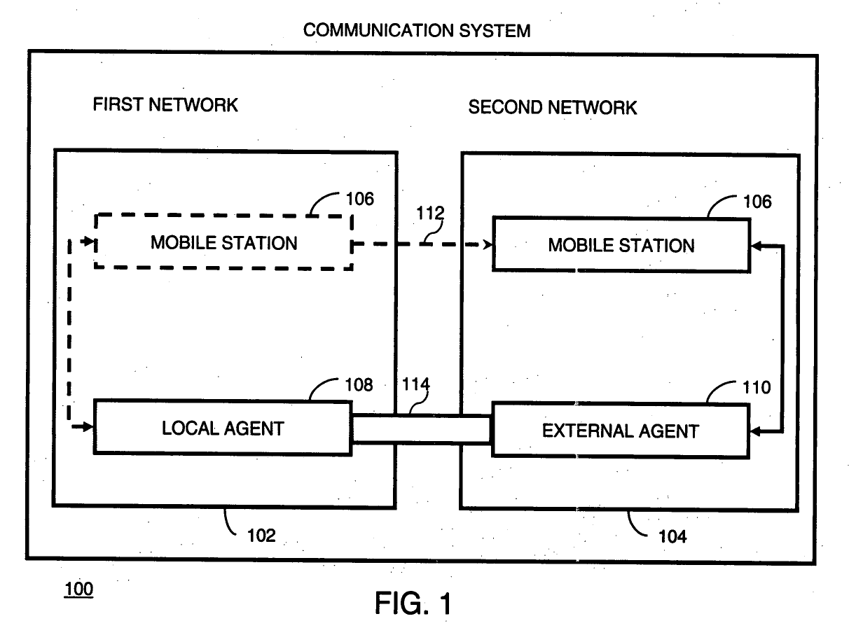

FIG. 1 is an example of an abstract model of a communication system 100 supporting communication of mobile station across different networks, in accordance with one embodiment of the invention. The communication system 100 is divided into a number of distinct networks. For example, the communication system 100 includes a first network 102, a second network 104. Examples of the first network 102 and the second network 104 include GPRS, WiFi, Worldwide Interoperability for Microwave Access (Wi-MAX), Enhanced Data for GSM Evolution (EDGE), Evolution Data Only (EVDO), Evolution Data Voice (EVDV), wireless communication standards from IEEE such as 802.11a, 802.11b, 802.11g, and the like. The first network 102 includes a mobile station 106 and a local agent 108. The second network 104 includes an external agent 110. In one embodiment, when the mobile station 106 moves from the first network 102 to the second network 104, as shown by dotted line 112. The mobile station 106 associated with the local agent 108 (in the first network 102) moves to the second network 104 and is now associated the external agent 110.

In one embodiment of the present invention, the mobile station 106 is a mobile phone. Exemplary mobile stations include cellular phones which are capable of requesting and obtaining a reverse tunnel, and are compliant with Request for Comments (RFC) 3344 and RFC 3024 published by the Internet Engineering Task Force (IETF). The external agent monitors the mobile stations visiting the network associated with it. The local agent on the other hand serves as a home serving site for a mobile station associated with it. For example, the external agent 110 monitors mobile stations visiting networks that are associated with the external agent 110, while the local agent 108 monitors the mobile stations that are associated with it, and are visiting other networks. These other networks may or may not be associated with the external agent 110. The communication of mobile station 106 across the first network 102 and the second network 104, takes place through a path called a tunnel. For example, a tunnel 114 is formed between the local agent 108 and the external agent 110. A tunnel starts sending the packets at a local agent and ends at a care-of address of the mobile station. For example, the tunnel 114 starts sending the packets from the local agent 108 (in the first network 102) to the external agent 110 (in the second network 104). On the other hand, a reverse tunnel starts sending the packets at the care-of address of a mobile station and terminates at the local agent of the mobile station. For example, the tunnel 114 starts sending the packets from the external agent 110 (in the second network 104) to the local agent 108 (in the first network 102).

Further, the local agent 108 also forwards all data packets addressed to a mobile station that is currently visiting a different network to its care-of address or a co-located care-of address. The care-of-address may be the address of an external agent with which the mobile station is currently associated. A co-located care-of address is an externally obtained local address which the mobile station has associated with one of its own network interface. In other words, the co-located care-of address is an address assigned solely to the mobile station from the external agent. The external agent 110 and the local agent 108 exchange data packets with each other using the tunnel 114. A two-way communication channel also exists between the external agent 110 and the mobile station 106. The communication system further includes other computational devices and mobile stations, which can exchange data packets with one another.

In accordance with an embodiment of the current invention, a registration request message is sent by the mobile station 106 to the local agent 108 via the external agent 110. The purpose of sending the registration request message is to inform the local agent 108 of the care-of address of the mobile station 106 by registering with it. Successful registration establishes a mobility binding in the local agent 108 between home address and the care-of-address of the mobile station 106. For the duration of the registration, the home address of the mobile station 106 is associated with its current care-of address. As a result, the local agent 108 forwards the data packets addressed to the home address over to the care-of address.

In various embodiments of the present invention, the local agent 108 is a router associated with the mobile station 106 that tunnels data packets to the mobile station 106 when it is visiting other networks. The external agent 110 can also be a router in a network that is being visited by the mobile station 106. The external agent 110 terminates the tunnel between the local agent 108 and the mobile station's care-of-address. Further, the external agent 110 also sends the data packets destined for the mobile station 106 and sent by the local agent 108. Also, the external agent 110 serves as a default router for any data packets that are sent by the mobile station 106 to any other network.

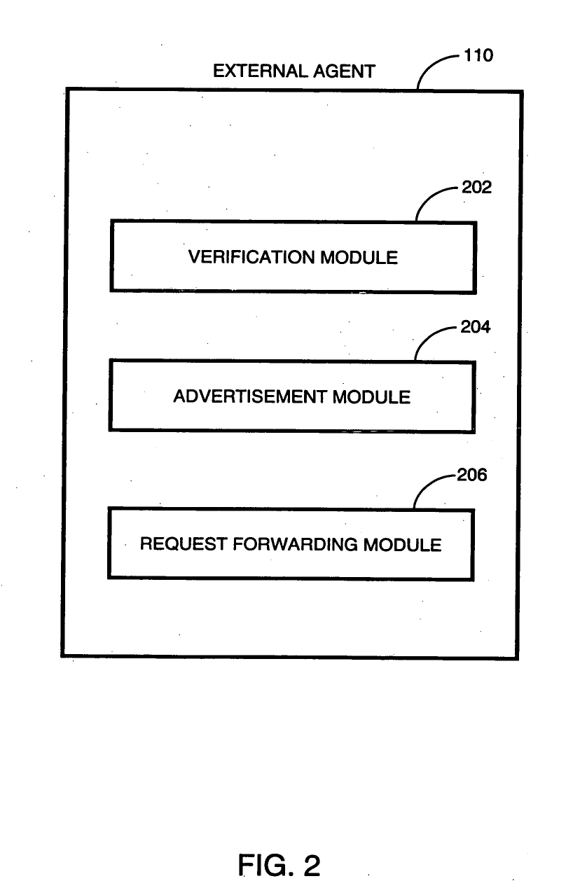

FIG. 2 is an example of an external agent 110 in accordance with one embodiment of the invention. The responsibilities of the external agent 110 include receiving a registration request message from the mobile station 106. The external agent 110 includes a verification module 202, an advertisement module 204, and a request forwarding module 206. The verification module 202 authenticates the mobile station 106. The authentication is performed when the mobile station 106 is entering a network monitored by the external agent 110. Once the mobile station 106 has been authenticated, the external agent 110 processes a registration request message sent by the mobile station 106. The authentication process is an optional step.

The advertisement module 204 includes an extension with the registration request message, which notifies the availability of support of the external agent 110 for a reverse tunnel to the local agent 108. The request forwarding module 206 forwards the registration request message along with the advertisement to the local agent 108. The local agent 108 sends back a reply to the external agent 110 in response to the registration request message. If the local agent 108 decides that a reverse tunnel is required (for example in the case where the mobile station is using a private IP address) and the external agent 110 supports the reverse tunnel, then the local agent 108 will request the external agent 110 to create the reverse tunnel using an extension to the registration reply message. This extension will be processed by the external agent and is not forwarded to the mobile station. In one embodiment of the present invention, the reverse tunnel is created based on the implementation of ingress filtering in the communication network 100. The reverse tunnel could also be created if the first network 102 assigns a private IP address or disparate IP address. Ingress filtering ensures that data packets must not be forwarded to a mobile station unless the source IP address is network topologically correct.

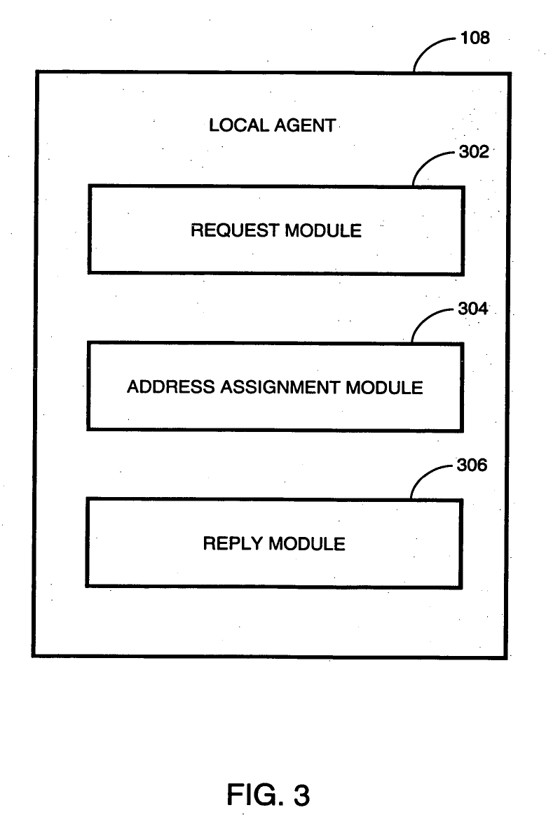

FIG. 3 is an example of a local agent 108 in accordance with one embodiment of the invention. The local agent 108 is responsible for keeping track of mobile stations that are associated with it, and currently visiting other sites. The local agent 108 also forwards all data packets addressed to the mobile station 106, which is currently visiting a different site, to its care-of address. Further, the local agent 108 processes a registration request message sent by the external agent 110. A request module 302 processes a registration request message along with an extension sent by the external agent 110. The extension advertises the support of the external agent 110 for the creation of the reverse tunnel 114. If the external agent 110 supports the creation of a reverse tunnel and the local agent decides that reverse tunnel 114 is required, the request module 302 sends a request to the external agent 110 to initiate the reverse tunnel in the form of extension to the registration reply message. In one embodiment of the present invention, the address assignment module 304 assigns an address to the mobile station 106. The assigned address can be a private address or a disparate address. The assigned address uniquely identifies the mobile station 106 to the local agent 108. The local agent 108 further includes a reply module 306 for sending a reply to a registration request message sent by the mobile station 106 via the external agent 110. The reply can include an extension requesting the external agent 110 to initiate a reverse tunnel.

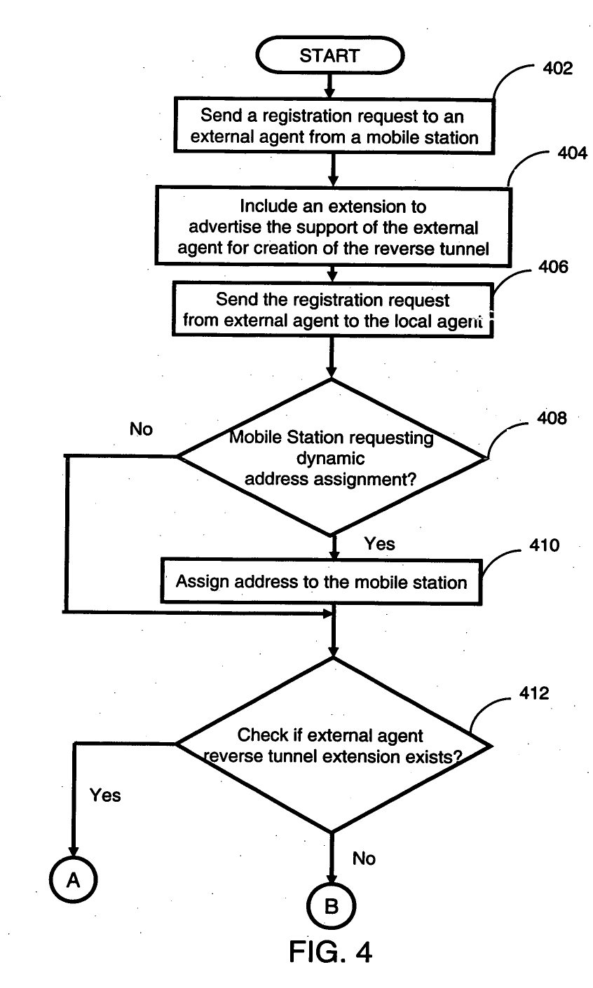

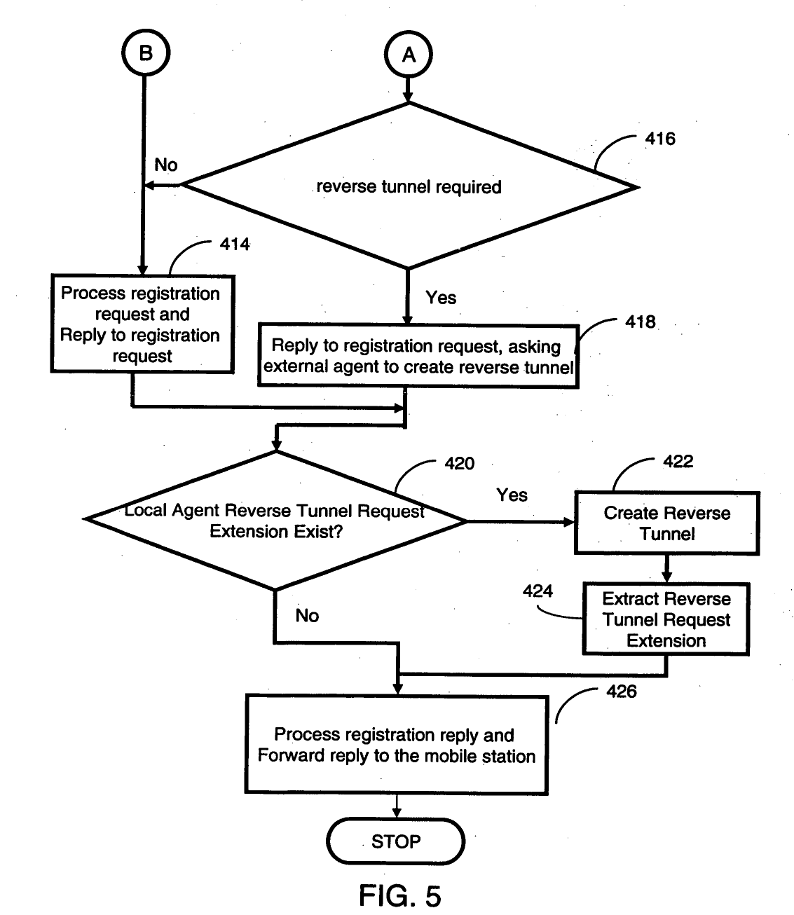

FIGS. 4 and 5 represent an exemplary process flow diagram illustrating a method for communicating between mobile stations in accordance with one embodiment of the invention. At step 402, the mobile station 106 sends a registration request message to the external agent 110. The registration request message informs the local agent 108 of the care-of address of the mobile station 106. At step 404, the external agent 110 includes an extension to advertise the support of the external agent 110 for creation of the reverse tunnel 114. If the registration request message from the mobile station 106 already includes a request for creation of the reverse tunnel, then the external agent 110 is not required to include an extension to advertise its support for reverse tunnel. At step 406, the registration request message is sent from external agent 110 to the local agent 108. At step 408, a check is made to determine whether the mobile station 106 has requested for dynamic address assignment. If yes, then at step 410, the local agent 108 assigns the dynamic address to the mobile station 106. If the mobile station has not requested at step 408, then the method makes a direct transition to step 412. At step 412, a check is performed on existing reverse tunnel by the local agent. If the reverse tunnel 114 is requested by the mobile station 106 (or if the external agent 110 reverse tunnel extension does not exist), then at step 414, the registration request message is processed and replied by the external agent 110. If the reverse tunnel 114 is not requested by the mobile station 106 (or if the external agent 110 reverse tunnel extension exists) at step 412, then another check, at step 416, is made if the reverse tunnel 114 is required. If the external agent does not support a reverse tunnel, it will not send the extension

If the reverse tunnel 114 is required at step 416, then a reply to the registration request message is sent asking the external agent 110 to create the reverse tunnel 114 is made at step 418. At step 420, it is checked whether the request from local agent 108 contains the extension. If the extension is found, then at step 422 the reverse tunnel is created. Further, at step 424, the extension in the reverse tunnel request is extracted. The extracted extension is then forwarded to the mobile station 106 at step 426. If at step 420, the extension in the reverse tunnel request from the local agent 108 does not exist, then the method directly transits to the step 426.

It is noted that steps 408 and 410 could also be performed after step 414 or 418. This will allow the local agent to assign globally routable address if the reverse tunnel creation is not possible because the mobile stations does not request the reverse tunnel or because the external agent does not support creation of the reverse tunnel.

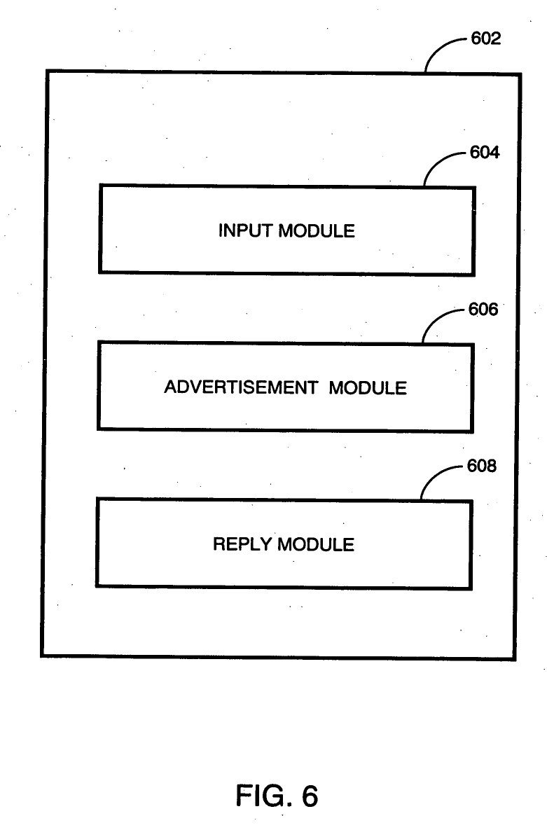

FIG. 6 represents a block diagram of an apparatus 602 for creating a reverse tunnel in a communication network, in accordance with an embodiment of the present invention. The apparatus 602 includes an input module 604, an advertisement module 606 and a reply module 608. The input module 604 receives a registration request message from the mobile station 106. The advertisement module 606 sends an extension with the registration request message. The reply module 608 sends a reply from the local agent 108 to the external agent 110.

The current invention provides several advantages. It solves the problems of ingress filtering and limited private address scenario by providing a method for the local agent to request for reverse tunnel. Further, it resolves the deployment issue of upgrading or recalling existing legacy mobile stations, which cannot request for a reverse tunnel. Instead of modifying the mobile stations or allowing an external entity to modify the registration request generated by the mobile station, the changes are made to the local agents and the external agents. This is a more cost effective solution and has a shorter time to market. Further, the behavior of the mobile station is controlled by the service providers. This is a preferable feature for systems that support roaming with other service providers.

It will be appreciated that embodiments of the invention described herein may be comprised of one or more conventional processors and unique stored program instructions that control the one or more processors to implement, in conjunction with certain non-processor circuits, some, most, or all of the functions of communication between mobile stations described herein. The non-processor circuits may include, but are not limited to, a radio receiver, a radio transmitter, signal drivers, clock circuits, power source circuits, and user input devices. As such, these functions may be interpreted as steps of a method to perform communication between mobile stations. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. A method for creating a reverse tunnel in a communication system, the communication system comprising at least one mobile station and a plurality of networks, the reverse tunnel being created from an external agent in a second network of the communication system to a local agent of a first network of the communication system, the method comprising:
receiving at the external agent a registration request message from a mobile station;
sending from the external agent to the local agent, an extension with the registration request message to advertise support for creation of the reverse tunnel; and
sending a reply from the local agent to the external agent containing an extension to request creation of the reverse tunnel if the extension from the external agent indicates that the reverse tunnel is supported by the external agent.

2. The method of claim 1, wherein the address has been assigned by the local agent.

3. The method of claim 1, wherein the reverse tunnel is created based on the implementation of ingress filtering in the communication network.

4. The method according to claim 1, further comprising authenticating the mobile station, wherein the external agent performs the authentication.

5. The method according to claim 1, further comprising sending the registration request message from the mobile station to the external agent.

6. The method according to claim 1, further comprising forwarding the registration request message to the local agent.

7. The method according to claim 1, further comprising forwarding the reply to the mobile station.

8. A system for creating a reverse tunnel in a communication system, the communication system comprising at least one mobile station and a plurality of networks, the reverse tunnel being created from an external agent in a second network of the communication system to a local agent of a first network of the communication system, the system comprising:
an external agent for receiving a registration request message from a mobile station, wherein the external agent provides an extension with the registration request message to advertise external agent's support for creation of the reverse tunnel to the local agent; and
a local agent for requesting the creation of the reverse tunnel using an extension in the reply, based on the extension in the registration request.

9. The system of claim 8, wherein the local agent comprises an address assignment module for assigning an address to the mobile station.

10. The system of claim 8, wherein the local agent further comprises a reply module for replying to the registration request message.

11. The system of claim 8, wherein the external agent comprises a verification module for authenticating the mobile station.

12. The system of claim 8, wherein the external agent comprises a request-forwarding module for forwarding the registration request message to the local agent.

13. The system of claim 8, wherein the external agent comprises a reply-forwarding module for forwarding a reply sent by the local agent to the mobile station.

14. An apparatus for creating a reverse tunnel in a communication system, the communication system comprising at least one mobile station and a plurality of networks, the reverse tunnel being created from an external agent in a second network of the communication system to a local agent of a first network of the communication system, the apparatus comprising:
an input module for receiving a registration request message from a mobile station;
an advertisement module for sending an extension with the registration request message; and
a reply module for sending a reply from the local agent to the external agent.

15. The apparatus according to claim 14, further comprising an authentication module for authenticating the mobile station.

16. The apparatus according to claim 14, further comprising a request dispatch module for sending the registration request message from the mobile station to the external agent.

17. The apparatus according to claim 14, further comprising a request forwarding module for forwarding the registration request message to the local agent.

18. The apparatus according to claim 14, further comprising a reply forwarding module for forwarding a reply to the mobile station.
